(19) United States
(12) Patent Application Publication
(10) Pub. No.: US 2022/0262119 A1
(43) Pub. Date: Aug. 18, 2022

(54) METHOD, APPARATUS AND DEVICE FOR AUTOMATICALLY GENERATING SHOOTING HIGHLIGHTS OF SOCCER MATCH, AND COMPUTER READABLE STORAGE MEDIUM

(71) Applicant: Beijing Moviebook Science and Technology Co., Ltd., Beijing (CN)

(72) Inventor: Minci HE, Beijing (CN)

(73) Assignee: Beijing Moviebook Science and Technology Co., Ltd., Beijing (CN)

(21) Appl. No.: 17/623,615

(22) PCT Filed: Nov. 19, 2020
(86) PCT No.: PCT/CN2020/130054

§ 371 Date: Dec. 29, 2021

(30) Foreign Application Priority Data
Dec. 25, 2019 (CN) 201911351659.0

(51) Int. Cl. G06V 20/40; G06V 10/774

(52) U.S. Cl. CPC G06V 20/47; G06V 10/774; G06V 20/42

(57) ABSTRACT

A method, apparatus and device for automatically generating shooting highlights of a soccer match, and a computer-readable storage medium are provided. The method includes acquiring video data of historical soccer matches, and carrying out training according to the video data of the historical soccer matches to obtain a soccer match video processing model; according to the soccer match video processing model, processing a target soccer match video, and obtaining video data and commentator audio data of the target soccer match video; extracting from the video data continuous image frames, wherein in the continuous images frames a goal appears to form video clips to be selected; performing identification on the commentator audio data to obtain times, wherein at the times a keyword of a preset expression related to shooting occurs in the target soccer match video.

### CROSS REFERENCE TO THE RELATED APPLICATIONS

This application is the national stage entry of International Application No. PCT/CN2020/130054, filed on Nov. 19, 2020, which is based upon and claims priority to Chinese Patent Application No. 201911351659.0 filed on Dec. 25, 2019, the entire contents of which are incorporated herein by reference.

### TECHNICAL FIELD

The present disclosure relates to the field of information processing, and in particular to a method, an apparatus and a device for automatically generating a shooting highlights collection for a football match, and a computer readable storage medium.

### BACKGROUND

Conventional football match shooting highlights are generally generated by a video editor manually, who determines shooting segments in a match video and edits the video. Manual editing generally requires the editor to have a certain understanding of the to-be-edited match and know how to determine a shooting segment in a match video. Further, the editor needs to view the entire match to ensure that no shooting segment is missed. Manual editing is inefficient for the increasingly diversified football matches, and cannot meet the needs of professional editing for a large amount of match videos.

### SUMMARY

It is an object of the embodiments of the present disclosure to provide a method, an apparatus and a device for automatically generating a shooting highlights collection for a football match is provided according to the, to solve the problem of the inefficient manual editing of football recorded videos.

To achieve the above object, the following technical solution is provided according to the present disclosure.

In a first aspect, a method for automatically generating a shooting highlights collection for a football match is provided according to the present disclosure, which includes: obtaining recorded video data of a historical football match, and performing training, based on the recorded video data of the historical football match to obtain a football match video processing model, the training including: marking a time position of a goal in a recorded video on the recorded video data of the historical football match and using the recorded video data of the historical football match having the marked time position as image training data, using an image clipped from a video as a training set, and generating the football match video processing model by training by using a stochastic gradient descent algorithm; processing, by using the football match video processing model, a recorded video of a target football match to obtain video data and commentator audio data of the recorded video of the target football match; extracting, from the video data, consecutive image frames including a goal to generate a candidate video segment; recognizing the commentator audio data to obtain a keyword appearance time instant at which a predetermined shooting-related word appears in the recorded video of the target football match; and generating a shooting highlights collection for the target football match based on the candidate video segment and the keyword appearance time instant. The generating a shooting highlights collection for the target football match based on the candidate video segment and the keyword appearance time instant includes: selecting a target video segment from among the candidate video segment based on the keyword appearance time instant; acquiring a start time instant and an end time instant of the target video segment; adjusting the start time instant of the target video segment backwardly by a preset period, to obtain a shooting start time instant; generating, from the recorded video of the target football match, a shooting video segment according to the shooting start time and the end time; and generating the shooting highlights collection for the target football match based on the shooting video segment.

Further, the recognizing the commentator audio data to obtain a keyword appearance time instant at which a predetermined shooting-related word appears in the recorded video of the target football match includes: acquiring, from the commentator audio data, a candidate audio segment in which a commentator is in a high mood, performing recognition on the candidate audio segment to obtain a candidate text segment, and obtaining the keyword appearance time instant in the candidate text segment.

Further, the football match video processing model includes a commentator voiceprint model, and processing, by using the football match video processing model, the recorded video of the target football match to obtain the commentator audio data of the recorded video of the target football match includes: extracting entire audio data of the recorded video of the target football match, obtaining matching audio data based on the entire audio data by using the commentator voiceprint model, and obtaining the commentator audio data based on the matching audio data.

Further, the commentator voiceprint model is obtained by training a DNN-HMM model by using the recorded video data of the historical football match.

In a second aspect, an apparatus for automatically generating a shooting highlights collection for a football match is provided according to the present disclosure, which includes a model training module and a processing module. The model training module is configured to obtain recorded video data of a historical football match, mark a time position of a goal in a recorded video on the recorded video data of the historical football match and use the recorded video data of the historical football match having the marked time position as image training data, use an image clipped from a video as a training set, and generate a football match video processing model by training by using a stochastic gradient descent algorithm. The processing module is configured to process, by using the football match video processing model, a recorded video of a target football match to obtain video data and commentator audio data of the recorded video of the target football match; extract, from the video data, consecutive image frames including a goal to generate a candidate video segment; recognize the commentator audio data to obtain a keyword appearance time instant at which a predetermined shooting-related word appears in the recorded video of the target football match; and generate a shooting highlights collection for the target football match based on the candidate video segment and the keyword appearance time instant.

Further, the processing module is configured to select a target video segment from among the candidate video segment based on the keyword appearance time instant; acquire a start time instant and an end time instant of the target video segment; adjust the start time instant of the target video segment backwardly by a preset period, to obtain a shooting start time instant; generate, from the recorded video of the target football match, a shooting video segment according to the shooting start time and the end time; and generate a shooting highlights collection for the target football match based on the shooting video segment.

Further, the processing module is configured to: acquire, from the commentator audio data, a candidate audio segment in which a commentator is in a high mood, perform recognition on the candidate audio segment to obtain a candidate text segment, and obtain the keyword appearance time instant in the candidate text segment.

Further, the football match video processing model includes a commentator voiceprint model, and the processing module is configured to extract entire audio data of the recorded video of the target football match, obtain matching audio data based on the entire audio data by using the commentator voiceprint model, and obtain the commentator audio data based on the matching audio data.

Further, the model training module is configured to train a DNN-HMM model by using the recorded video data of the historical football match to obtain the commentator voiceprint model.

In a third aspect, an electronic device is provided according to an embodiment of the present disclosure, which includes: at least one processor and at least one memory. The memory is configured to store one or more program instructions, and the processor is configured to execute the one or more program instructions to perform the above method for automatically generating a shooting highlights collection for a football match.

A computer-readable storage medium having one or more computer program instructions stored thereon according to an embodiment of the present disclosure. The one or more computer program instructions are configured to perform the above method for automatically generating a shooting highlights collection for a football match.

The technical solutions according to the embodiments of the present disclosure have at least the following advantages.

With the method, the apparatus and the device for automatically generating a shooting highlights collection for a football match according to the embodiments of the present disclosure, the football match video processing model for processing recorded videos of football matches can be generated based on the recorded video data of the historical football match, and a shooting highlights collection can be automatically and rapidly generated by using the football match video processing model based on the time position at which the goal appears in the recorded video and the time position at which the shooting-related word appears in the recorded video, thereby improving the efficiency of editing a football match video, and satisfying requirements for professionally editing a large amount of match videos.

### BRIEF DESCRIPTION OF THE DRAWINGS

FIG. 1 is a flow char of a method for automatically generating a shooting highlights collection for a football match according to an embodiment of the present disclosure; and

FIG. 2 is a block diagram showing a structure of an apparatus for automatically generating a shooting highlights collection for a football match according to an embodiment of the present disclosure.

### DETAILED DESCRIPTION OF THE EMBODIMENTS

The following embodiments illustrate the implementation of the present disclosure. Those familiar with this technology can easily understand the other advantages and effects of the present disclosure from the content disclosed in this specification.

In the following description, for the purpose of illustration rather than limitation, specific details such as a specific system structure, interface, technology, and the like are proposed for a thorough understanding of the present disclosure. However, it should be clear to those skilled in the art that the present disclosure can also be implemented in other embodiments without these specific details. In other cases, detailed descriptions of well-known systems, circuits, and methods are omitted to avoid unnecessary details from obstructing the description of the present disclosure.

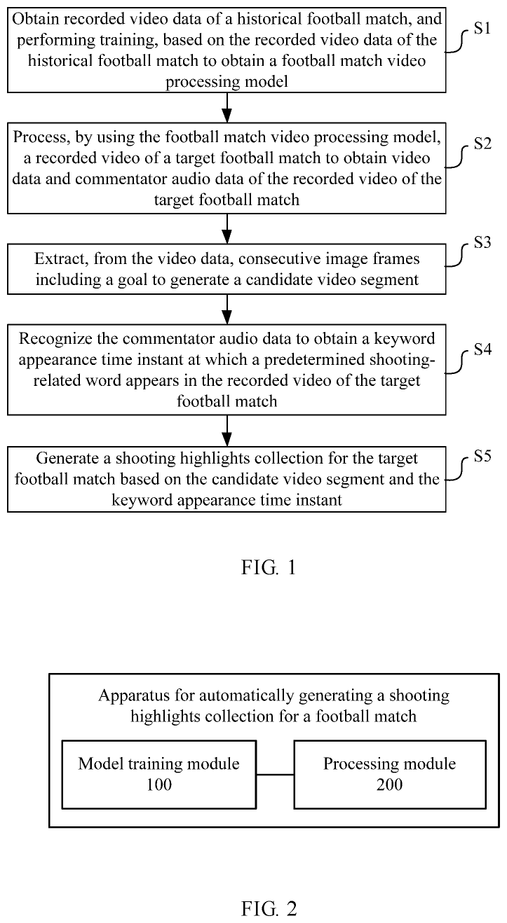

FIG. 1 is a flow char of a method for automatically generating a shooting highlights collection for a football match according to an embodiment of the present disclosure. As shown in FIG. 1, the method for automatically generating a shooting highlights collection for a football match includes the following steps S1 to S5.

In step S1, recorded video data of a historical football match is obtained, and training is performed based on the recorded video data of the historical football match to obtain a football match video processing model.

In an embodiment of the present disclosure, recorded video data of a domestic football match (such as the Chinese Super League) may be selected as a part of the recorded video data of the historical football match, and recorded video data of a foreign football match (such as Bundesliga, Serie A, and the like) may be selected as another part of the recorded video data of the historical football match.

A time position of a goal in a recorded video is marked on the recorded video data of the historical football match and the recorded video data of the historical football match having the marked time position is used as image training data, an image clipped from a video is used as a training set (the image clipped from the video includes an image including the goal, and other images), and an analysis model is generated by using a Stochastic Gradient Descent (SGD) algorithm. The analysis model is tested by using testing data to determine whether the analysis model is capable of accurately recognizing a goal in an image frame. If the analysis model cannot accurately the goal in the image frame, training is repeated until the goal in the image frame is accurately recognized, to obtain a video processing model.

The football match video processing model includes a commentator voiceprint model. Several fixed commentators commentate on a domestic football match or a foreign football match. Therefore, according to the present disclosure, commentary audio of the recorded video of the historical football match is extracted, commentary text corresponding to the audio is used as voiceprint training data, and training is performed based on the extracted audio and text by using the DNN-based algorithm to generate the commentator voiceprint model. A voice feature of the commentator is obtained by using the commentator voiceprint model as a voiceprint identification of the commentator, so that non-commentator audio interference data can be removed in subsequent audio processing.

The video processing model and the commentator voiceprint model form the football game video processing model.

In step S2, a recorded video of target football match is processed by using the football match video processing model to obtain video data and commentator audio data of the recorded video of the target football match.

Video data and audio data are separated from the recorded video of the target football match by using the football match video processing model, to obtain the video data and entire audio data of the recorded video of the target football match. Matching audio data is obtained based on the entire audio data by using the commentator voiceprint model, and is used as commentator audio data.

In step S3, consecutive image frames including a goal are extracted from the video data to generate a candidate video segment.

Each image frame in the video data is recognized by using the football match video processing model, to extract consecutive image frames including the goal as the candidate video segment.

In step S4, the commentator audio data is recognized to obtain a keyword appearance time instant at which a predetermined shooting-related word appears in the recorded video of the target football match.

In an embodiment of the present disclosure, step S4 includes: acquiring, from the commentator audio data, a candidate audio segment in which a commentator is in a high mood; performing recognition on the candidate audio segment to obtain a candidate text segment; and obtaining the keyword appearance time instant in the candidate text segment.

In a football match, a player's shot usually causes the commentator's mood to rise. Therefore, in the present disclosure, audio recognition is performed on the candidate audio segment in the commentator audio data in which the commentator is in a high mood to obtain the candidate text segment corresponding to the candidate audio segment, and the keyword appearance time instant is obtained based on the candidate text segment. The predetermined shooting-related word includes shooting, hitting, scoring, and the like. In this embodiment, the time position of the predetermined shooting-related word can be rapidly found in the recorded video of the target football match.

It should be noted that the execution sequence of steps S3 and S4 is not limited in the present disclosure. Step S3 may be executed before or after S4, or steps S3 and S4 may be executed simultaneously.

In step S5, a shooting highlights collection for the target football match is generated based on the candidate video segment and the keyword appearance time instant.

In an embodiment of the present disclosure, step S5 includes: selecting a target video segment from among the candidate video segment based on the keyword appearance time instant; acquiring a start time instant and an end time instant of the target video segment; adjusting the start time instant of the target video segment backwardly by a preset period, to obtain a shooting start time instant; generating, from the recorded video of the target football match, a shooting video segment according to the shooting start time and the end time; and generating a shooting highlights collection for the target football match based on the shooting video segment.

Among the candidate video segment, a video segment having a time period in the recorded video corresponding to a recognition result of the commentator audio data in which the predetermined shooting-related word appears is selected as the target video segment.

Next, the start time instant and the end time instant of the target video segment in the recorded video of the target football match are obtained. For example, the target video segment is at 15 minutes 8 seconds to 15 minutes 12 seconds in the recorded video of the target football match.

Next, the start time instant of the target video segment is adjusted backwardly by a preset period, to obtain the shooting start time instant. This is because, in a case of a shooting from long distance, if the time instant at which the goal appears is used as the start time instant of the shooting video segment, the football is flying at the beginning of the shooting video segment, and an initial state of shooting cannot be displayed, reducing the viewing experience of viewers. Therefore, in this embodiment, the start time instant of the target video segment is adjusted backwardly by the preset period relative to a video playback direction, to effectively avoid the problem that the target video segment cannot show the initial state of the shooting. In an example of the present disclosure, the preset period is 3 to 10 seconds, and is preferably 5 seconds.

For example, the target video segment is at 15 minutes 8 seconds to 15 minutes 12 seconds in the recorded video of the target football match, and the shooting video segment may be at 15 minutes 3 seconds to 15 minutes 12 seconds in the recorded video of the target football match.

All shooting video segments in the recorded video of the target football match are clipped based on the time positions, to generate the shooting highlights collection for the target football match.

With the method for automatically generating a shooting highlights collection for a football match according to the embodiments of the present disclosure, the football match video processing model for processing recorded videos of football matches can be generated based on the recorded video data of the historical football match, and a shooting highlights collection can be automatically and rapidly generated by using the football match video processing model based on the time position at which the goal appears in the recorded video and the time position at which the shooting-related word appears in the recorded video, thereby improving the efficiency of editing a football match video, and satisfying requirements for professionally editing a large amount of match videos.

FIG. 2 is a block diagram showing a structure of an apparatus for automatically generating a shooting highlights collection for a football match according to an embodiment of the present disclosure. As shown in FIG. 2, the apparatus for automatically generating a shooting highlights collection for a football match includes a model training module 100 and a processing module 200.

The model training module 100 is configured to obtain recorded video data of a historical football match, and perform training, based on the recorded video data of the historical football match to obtain a football match video processing model. The model training module 100 marks a time position of a goal in a recorded video on the recorded video data of the historical football match and uses the recorded video data of the historical football match having the marked time position as image training data, uses an image clipped from a video as a training set, and generates the football match video processing model by training by using a stochastic gradient descent algorithm.

The processing module 200 is configured to process, by using the football match video processing model, a recorded video of a target football match to obtain video data and commentator audio data of the recorded video of the target football match; extract, from the video data, consecutive image frames including a goal to generate a candidate video segment; recognize the commentator audio data to obtain a keyword appearance time instant at which a predetermined shooting-related word appears in the recorded video of the target football match; and generate a shooting highlights collection for the target football match based on the candidate video segment and the keyword appearance time instant.

In an embodiment of the present disclosure, the processing module 200 is configured to select a target video segment from among the candidate video segment based on the keyword appearance time instant; acquire a start time instant and an end time instant of the target video segment; adjust the start time instant of the target video segment backwardly by a preset period, to obtain a shooting start time instant; generate, from the recorded video of the target football match, a shooting video segment according to the shooting start time and the end time; and generate a shooting highlights collection for the target football match based on the shooting video segment.

In an embodiment of the present disclosure, the processing module 200 is configured to: acquire, from the commentator audio data, a candidate audio segment in which a commentator is in a high mood, perform recognition on the candidate audio segment to obtain a candidate text segment, and obtain the keyword appearance time instant in the candidate text segment.

In an embodiment of the present disclosure, the football match video processing model includes a commentator voiceprint model, and the processing module 200 is configured to extract entire audio data of the recorded video of the target football match, obtain matching audio data based on the entire audio data by using the commentator voiceprint model, and obtain the commentator audio data based on the matching audio data.

In an embodiment of the present disclosure, the model training module 100 is configured to train a DNN-HMM model by using the recorded video data of the historical football match to obtain the commentator voiceprint model.

It is to be noted that embodiments of the system for automatically generating a shooting highlights collection for a football match according to the embodiments of the present disclosure are similar to the embodiments of the method for automatically generating a shooting highlights collection for a football match according to the embodiments of the present disclosure. For details, reference can be made to the description of the method for automatically generating a shooting highlights collection for a football match, which is not repeated in order to reduce redundancy.

An electronic device is further provided according an embodiment of the present disclosure, which includes: at least one processor and at least one memory. The memory is configured to store one or more program instructions. The processor is configured to execute the one or more program instructions to perform the above method for automatically generating a shooting highlights collection for a football match.

A computer-readable storage medium having computer program instructions stored thereon is further provided according an embodiment of the present disclosure. The computer program instructions, when executed by a computer, cause the computer to perform the above method for automatically generating a shooting highlights collection for a football match.

In an embodiment of the present invention, the processor may be an integrated circuit chip with signal processing capability. The processor may be a general-purpose processor, a Digital Signal Processor (DSP), an Application Specific Integrated Circuit (ASIC), a Field Programmable Gate Array (FPGA) or another programmable logic device, discrete gate or transistor logic device, or discrete hardware component, that is capable of performing or executing the methods, steps, and logical block diagrams disclosed in the embodiments of the present disclosure.

The general-purpose processor may be a microprocessor. Alternatively, the processor may be any conventional processor, or the like. The steps of the method disclosed in the embodiments of the present disclosure may be directly embodied as being executed and implemented by a hardware decoding processor, or executed and implemented by a combination of hardware and software modules in the decoding processor. The software module may be located in a mature storage medium in the field, such as a random access memory, a flash memory, a read-only memory, a programmable read-only memory, an electrically erasable programmable memory, or a register. The processor reads information in the storage medium and performs the steps of the above method in combination with its hardware.

The storage medium may be a memory, for example, a volatile memory or a non-volatile memory, or may include both the volatile memory and the non-volatile memory.

The non-volatile memory may be a Read-Only Memory (ROM), a programmable read-only memory (Programmable ROM, PROM), an erasable programmable read-only memory (Erasable PROM, EPROM), and an electrically erasable programmable read-only memory (Electrically EPROM, EEPROM) or a flash memory.

The volatile memory may be a Random Access Memory (RANI), which is used as an external cache. By way of exemplary but not restrictive, many forms of RAM are available, such as a static random access memory (Static RANI, SRAM), a dynamic random access memory (Dynamic RAM, DRAM), a synchronous dynamic random access memory (Synchronous DRAM, SDRAM for short), a double data rate synchronous dynamic random access memory (Double Data Rate SDRAM, DDRSDRAM for short), an enhanced synchronous dynamic random access memory (Enhanced SDRAM, ESDRAM for short), a synchronous link dynamic random access memory (Synchronous Link DRAM, SLDRAM for short) and a Direct Rambus random access memory (Direct Rambus RAM, DRRAM for short).

The storage media described in the embodiments of the present disclosure are intended to include, but are not limited to, these and any other suitable types of memory.

Those skilled in the art should understood that in one or more of the above examples, the functions described in the present disclosure may be implemented by a combination of hardware and software. When implemented by software, the corresponding function may be stored in a computer-readable medium or transmitted as one or more instructions or codes on the computer-readable medium. The computer-readable medium includes a computer storage medium and a communication medium, where the communication medium includes any medium that facilitates the transfer of a computer program from one place to another. The storage medium may be any available medium that is accessible by a general-purpose or special-purpose computer.

In the above embodiments, the objectives, technical solutions and beneficial effects of the present disclosure are described in further detail. It should be understood that the above descriptions are only specific embodiments of the present disclosure and are not intended to limit the scope of the present disclosure. Any modification, equivalent replacement, improvement, and the like made on the basis of the technical solution of the present disclosure should fall within the scope of the present disclosure.

What is claimed is:

1. A method for automatically generating a shooting highlights collection for a football match, comprising the following steps of:
obtaining recorded video data of a historical football match, and performing a training, based on the recorded video data of the historical football match to obtain a football match video processing model, the training comprising: marking a time position of a goal in a recorded video on the recorded video data of the historical football match and using the recorded video data of the historical football match having the time position as image training data, using an image clipped from a video as a training set, and generating the football match video processing model by the training by using a stochastic gradient descent algorithm;
processing, by using the football match video processing model, a recorded video of a target football match to obtain video data and commentator audio data of the recorded video of the target football match;
extracting, from the video data, consecutive image frames comprising the goal to generate candidate video segments;
recognizing the commentator audio data to obtain a keyword appearance time instant, wherein a predetermined shooting-related word appears at the keyword appearance time instant in the recorded video of the target football match; and
generating the shooting highlights collection for the target football match based on the candidate video segments and the keyword appearance time instant, comprising:
selecting a target video segment from among the candidate video segments based on the keyword appearance time instant;
acquiring a start time instant and an end time instant of the target video segment;
adjusting the start time instant of the target video segment backwardly by a preset period, to obtain a shooting start time instant;
generating, from the recorded video of the target football match, a shooting video segment according to the shooting start time instant and the end time instant; and
generating the shooting highlights collection for the target football match based on the shooting video segment.

2. The method according to claim 1, wherein the step of recognizing the commentator audio data to obtain the keyword appearance time instant, wherein the predetermined shooting-related word appears at the keyword appearance time instant in the recorded video of the target football match comprises:
acquiring, from the commentator audio data, a candidate audio segment, wherein a commentator is in a high mood in the candidate audio segment,
performing a recognition on the candidate audio segment to obtain a candidate text segment, and
obtaining the keyword appearance time instant in the candidate text segment.

3. The method according to claim 1, wherein
the football match video processing model comprises a commentator voiceprint model, and the step of processing, by using the football match video processing model, the recorded video of the target football match to obtain the commentator audio data of the recorded video of the target football match comprises:
extracting entire audio data of the recorded video of the target football match,
obtaining matching audio data based on the entire audio data by using the commentator voiceprint model, and
obtaining the commentator audio data based on the matching audio data.

4. The method according to claim 3, wherein the commentator voiceprint model is obtained by training a DNN-HMM model by using the recorded video data of the historical football match.

5. An apparatus for automatically generating a shooting highlights collection for a football match, comprising:
a model training module, configured to obtain recorded video data of a historical football match, mark a time position of a goal in a recorded video on the recorded video data of the historical football match and use the recorded video data of the historical football match having the time position as image training data, use an image clipped from a video as a training set, and generate a football match video processing model by a training by using a stochastic gradient descent algorithm;
a processing module configured to
process, by using the football match video processing model, a recorded video of a target football match to obtain video data and commentator audio data of the recorded video of the target football match;
extract, from the video data, consecutive image frames comprising the goal to generate candidate video segments;
recognize the commentator audio data to obtain a keyword appearance time instant, wherein a predetermined shooting-related word appears at the keyword appearance time instant in the recorded video of the target football match;
select a target video segment from among the candidate video segments based on the keyword appearance time instant;
acquire a start time instant and an end time instant of the target video segment;
adjust the start time instant of the target video segment backwardly by a preset period, to obtain a shooting start time instant;
generate, from the recorded video of the target football match, a shooting video segment according to the shooting start time instant and the end time instant; and
generate the shooting highlights collection for the target football match based on the shooting video segment.

6. The apparatus according to claim 5, wherein the processing module is further configured to:
acquire, from the commentator audio data, a candidate audio segment, wherein a commentator is in a high mood in the candidate audio segment,
perform a recognition on the candidate audio segment to obtain a candidate text segment, and
obtain the keyword appearance time instant in the candidate text segment.

7. An electronic device, comprising: at least one processor and at least one memory, wherein
the memory is configured to store one or more program instructions, and
the processor is configured to execute the one or more program instructions to perform the method according to claim 1.

8. A computer-readable storage medium having one or more computer program instructions stored on the computer-readable medium, wherein the one or more computer program instructions are configured to perform the method according to claim 1.

9. The electronic device according to claim 7, wherein the step of recognizing the commentator audio data to obtain the keyword appearance time instant, wherein the predetermined shooting-related word appears at the keyword appearance time instant in the recorded video of the target football match comprises:
acquiring, from the commentator audio data, a candidate audio segment, wherein a commentator is in a high mood in the candidate audio segment,
performing a recognition on the candidate audio segment to obtain a candidate text segment, and
obtaining the keyword appearance time instant in the candidate text segment.

10. The electronic device according to claim 7, wherein
the football match video processing model comprises a commentator voiceprint model, and the step of processing, by using the football match video processing model, the recorded video of the target football match to obtain the commentator audio data of the recorded video of the target football match comprises:
extracting entire audio data of the recorded video of the target football match,
obtaining matching audio data based on the entire audio data by using the commentator voiceprint model, and
obtaining the commentator audio data based on the matching audio data.

11. The electronic device according to claim 10, wherein the commentator voiceprint model is obtained by training a DNN-HMM model by using the recorded video data of the historical football match.

12. The computer-readable storage medium according to claim 8, wherein the step of recognizing the commentator audio data to obtain the keyword appearance time instant, wherein the predetermined shooting-related word appears at the keyword appearance time instant in the recorded video of the target football match comprises:
acquiring, from the commentator audio data, a candidate audio segment, wherein a commentator is in a high mood in the candidate audio segment,
performing a recognition on the candidate audio segment to obtain a candidate text segment, and
obtaining the keyword appearance time instant in the candidate text segment.

13. The computer-readable storage medium according to claim 8, wherein
the football match video processing model comprises a commentator voiceprint model, and the step of processing, by using the football match video processing model, the recorded video of the target football match to obtain the commentator audio data of the recorded video of the target football match comprises:
extracting entire audio data of the recorded video of the target football match,
obtaining matching audio data based on the entire audio data by using the commentator voiceprint model, and
obtaining the commentator audio data based on the matching audio data.

14. The computer-readable storage medium according to claim 13, wherein the commentator voiceprint model is obtained by training a DNN-HMM model by using the recorded video data of the historical football match.
